(19) United States
(12) Patent Application Publication
(10) Pub. No.: US 2019/0185715 A1
(43) Pub. Date: Jun. 20, 2019

(54) POLISHING LIQUID FOR CMP AND PREPARATION METHOD AND USE THEREOF

(71) Applicant: Beijing Chuangyu Technology Co., Ltd., Beijing (CN)

(72) Inventors: Lejun Wang, Beijing (CN); Linlin Li, Beijing (CN); Shijia Song, Beijing (CN); Guiyong Liu, Beijing (CN); Dongyang Peng, Beijing (CN); Hong Jiang, Beijing (CN)

(21) Appl. No.: 16/118,946

(22) Filed: Aug. 31, 2018

(30) Foreign Application Priority Data
Dec. 19, 2017 (CN) 201711376766.X
Dec. 19, 2017 (CN) 201711377699.3

(51) Int. Cl. C09G 1/02; C09K 3/14; B24B 37/04

(52) U.S. Cl. CPC C09G 1/02; B24B 37/044; C09K 3/1409

(57) ABSTRACT

The present invention relates to a polishing liquid for CMP and preparation method thereof. 100 parts by weight of the polishing liquid comprises: 0.1 to 50 parts of abrasive, 0.001 to 0.4 part of surfactant, 0.001 to 0.6 part of film former, and 0.05 to 10 parts of pH regulator, and 0.01 to 4 parts of polishing accelerator, and deionized water in balance; and the pH value of the polishing liquid is 9.5 to 12.5. When a GaAs wafer is polished with the polishing liquid of the present invention, various performance indexes such as polishing removal rate, surface roughness and TTV of the polished wafer are excellent, and the polishing liquid is easy to be washed away, does not corrode equipment, and does not introduce harmful metal ions. The polishing liquid of the present invention can be used continuously and circularly for a long period of 6 to 10 hours, which greatly saves resources and reduces the use cost of the polishing liquid. Furthermore, the steps and operations of the method of the present application are simple and can make each raw material fully play its function.

### CLAIM OF PRIORITY

This application claims priority to Chinese Patent Application No. 201711376766.X, filed Dec. 19, 2017 and Chinese Patent Application No. 201711377699.3, filed Dec. 19, 2017, each of which are fully incorporated herein by reference in their entireties.

### TECHNICAL FIELD

The present invention belongs to the technical field of semiconductor processing, particularly, to a polishing liquid for CMP and use of the same in the polishing of GaAs wafer.

### BACKGROUND ART

Gallium arsenide (GaAs) is an extremely important second-generation semiconductor material with the characteristics of high electron mobility, wide band gap, direct bandgap, and low power consumption, and plays a very important role in microelectronic and optoelectronic industries, especially in the fields of defense and satellite communication. The semiconductor device made by GaAs has the advantages of excellent performance at high frequency, high temperature, and low temperature, low noise, and strong radiation resistance. Although GaAs has superior performance, it is decomposed at high temperature, which makes a high technical difficulty in producing high-purity single crystal materials with an ideal chemical composition. GaAs is the compound semiconductor material with the largest production volume and widest application at present, and is the semiconductor material that second in importance only to silicon.

Due to the excellent characteristics of GaAs material, China and major countries in the world are vigorously supporting the prosperous development of their related industries. With the entry of smart phones into the 4G era, as well as the rise of 5G and Internet of Things, the demand for multi-mode and multi-frequency GaAs microwave power devices will increase significantly. In the coming years, with the rapid development of China's optoelectronic communications and other new industries (such as solar thin film), the market demand for GaAs materials will be even greater. It is estimated that by 2022, the market sales of China's GaAs will reach 10 billion yuan.

GaAs circuits and devices take the polished GaAs wafers as substrates. The surface quality of the polished wafers directly affects the performance and yield of the devices. The better the surface quality of the polished wafers, the higher the performance and yield of the device. The GaAs wafer is made by the following steps: synthesizing and growing pure Ga and pure to give a single crystal material, and then subjecting the material to the processes of cutting, milling, polishing and the like to give the GaAs wafer. Therefore, the polishing process is the key process for the GaAs wafer to finally meet the requirements of super-precision surface. At present, the polishing process commonly used at home and abroad is chemical mechanical polishing (CMP) process. The CMP process is a combined process in which chemical etching and mechanical grinding are carried out alternately, and it combines the advantages of chemical polishing and mechanical polishing. With the help of the chemical etching effect of the polishing liquid and the mechanical grinding effect of the abrasive, the GaAs wafer is allowed to obtain an ultra-smooth and ultra-flat surface on the basis of the good performance of polishing machines and suitable polishing pads. Thus the Polishing liquid for CMP is the factor that determines the surface quality of the polished wafer in addition to the polishing machine and polishing pad.

Chinese Patent No. CN106833389A discloses a chemical mechanical polishing composition suitable for gallium arsenide wafers. Although the polishing composition has a high removal rate, the surface roughness of the polished wafer is high, only less than 1 nm, and the polishing composition is acidic, leading to serious corrosion to the equipment during use, and thereby introducing metal contamination.

China Patent No. CN105382676A discloses a polishing method for a gallium arsenide wafer. The surface roughness of the wafer polished by the polishing liquid that is prepared according to the polishing method is not more than 0.4 nm. Although the surface roughness is better, it needs to be further improved. Moreover, the process is complicated and requires two steps of polishing, and the TTV (total thickness variation) of the polished wafer is significantly deteriorated.

Chinese patents Nos. CN101475778A and CN101081966A disclose a polishing composition for a gallium arsenide wafer and preparation method thereof, and a polishing liquid for a gallium arsenide wafer and preparation method thereof, respectively. When polishing using the two polishing liquids, both the polishing removal rate and the roughness of polished surface can hardly meet the desired requirements.

In addition, there have been some reports in domestic patents on chemical mechanical polishing liquid for GaAs wafer processing, and the homemade chemical mechanical polishing liquids for GaAs wafer processing are used by the domestic enterprises. However, they are all disposable, and cannot be recycled, and the chemical mechanical polishing liquids for GaAs wafer processing that can be recycled have not been reported or used. Disposable polishing liquid not only causes great waste, but also greatly increases the production cost. Therefore, it is necessary to systematically study the chemical mechanical polishing liquid for GaAs wafer processing that can be recycled.

On the other hand, with respect to the Polishing liquid for CMP, in addition to the composition, the preparation method has some influence on its performance. Regarding the reports on the preparation methods of Polishing liquid for CMPs for GaAs wafers, there are a few reports in the prior Chinese patent documents, among which only two Chinese patents, CN101475778A and CN101081966A, relate to such report, but the preparation methods in the two patents mentioned above are all have some problems, such as high operating cost. Therefore, there is a need to further study the preparation method of Polishing liquid for CMP.

### SUMMARY OF THE INVENTION

The first purpose of the present invention is to provide a polishing liquid for CMP for GaAs wafer processing, wherein 100 parts by weight of the polishing liquid comprises: 0.1 to 50 parts of abrasive, 0.001 to 0.4 part of surfactant, 0.001 to 0.6 part of film former, and 0.05 to 10 parts of pH adjuster, and 0.01 to 4 parts of polishing accelerator, and deionized water in balance; and the pH value of the polishing liquid is 9.5 to 12.5.

Preferably, 100 parts by weight of the polishing liquid comprises: 1 to 45 parts of abrasive, 0.005 to 0.2 part of surfactant, 0.02 to 0.4 part of film former, and 0.1 to 8 parts of pH adjuster, and 0.05 to 2 parts of polishing accelerator, and deionized water in balance; and the pH value of the polishing liquid is 10 to 12.

Preferably, the abrasive is one or more of silica sol, alumina sol, zirconia sol, ceria sol, and titania sol. The above-mentioned abrasive is an aqueous porous colloidal abrasive which has a hardness much lower than that of GaAs material, does not cause any physical damage on the wafer, and is advantageous to the improvement of the surface roughness of the wafer.

Preferably, the abrasive material has a particle size of 5 nm to 150 nm, and the sol has a pH of 8 to 10. The present invention can be achieved by the sol with a concentration commonly used in the art, and the present invention is not particularly limited thereto. For example, the concentration of the silica sol, alumina sol, zirconia sol, ceria sol, and titania sol may be 10% by weight or 50% by weight. More preferably, the particle size of the abrasive material in the sol is 10 nm to 100 nm.

Preferably, the surfactant is one or more of alkylphenol ethoxylates, fatty alcohol polyoxyethylene ether, polyoxyethylene fatty acid, ethylene oxide adducts of polypropylene glycol, sorbitan esters, Tweens, and alkylolamides.

Further preferably, the surfactant is octylphenol polyoxyethylene ether, fatty alcohol polyoxyethylene ether, allyl polyoxyethylene polyoxypropylene epoxy ether, Lauric diethanolamide, Tweens, or polyoxyethylene fatty acid. The surfactant used in the present invention can maintain the uniform dispersion of the abrasive and greatly reduce the surface tension of the polishing liquid, and can be used together with the film former used in the present invention, such that the polishing liquid forms a more uniform film layer on the surface of the polishing pad and wafer, and is more evenly distributed on the polishing pad, thereby helping to improve the surface roughness and TTV of the wafer.

Preferably, the film former is one or more of cellulose ethers, acrylic copolymers, polyethylene-based copolymers, hydrocarbon copolymers, organosilicon polymers, and their mutually-modified species.

Further preferably, the film former is Acrylic Acid-2-Hydroxypropyl Acrylate Copolymer, carboxymethyl hydroxyethyl cellulose, hydroxyethyl carboxymethyl cellulose, polyethylene glycol, or water-soluble silicone oil. The film former used in the present invention is favorable for the polishing liquid to form a uniform film layer on the surface of the polishing pad and wafer, such that the polishing liquid is evenly distributed on the polishing pad.

Preferably, the pH adjuster is one or more of hydroxide, alkaline inorganic salt, primary amine, tertiary amine, quaternary ammonium base and imine.

Further preferably, the pH adjuster is ammonia water, sodium carbonate, triethanolamine, methylamine, tetramethylammonium hydroxide, or a combination of sodium carbonate and tetramethylammonium hydroxide, or a combination of methylamine and hexamethylenetetramine. The pH adjuster used in the present invention does not chemically react with other components in the polishing liquid, but will chemically react with GaAs, and thus the pH of the polishing liquid can be kept stable during long time storage. The pH adjuster has synergistic effect with the polishing accelerator, such that the polishing liquid provides a stable and higher removal rate.

Preferably, the polishing accelerator is one or more of ferrate, persulfate, permanganate, dichromate, perchlorate, hypochlorite, and periodate.

Further preferably, the polishing accelerator is a sodium or potassium salt of the above-mentioned salt. The polishing accelerator used in the present invention is stable in the polishing liquid, and will not be gradually decomposed or hydrolyzed over time. The reaction product with GaAs can be removed more easily, such that the polishing efficiency of the polishing liquid is stable, and the polished wafer is easy to clean.

As a preferred formulation, 100 parts by weight of the polishing liquid comprises: 1 to 45 parts of abrasive, 0.005 to 0.2 part of surfactant, 0.02 to 0.4 part of film former, and 0.1 to 8 parts of pH adjuster, and 0.05 to 2 parts of polishing accelerator, and deionized water in balance; and the pH value of the polishing liquid is 10 to 12.

The abrasive is one or more of silica sol, alumina sol, zirconia sol, ceria sol, and titania sol; and the pH of the sol is 8 to 10, the particle size of the abrasive material in the sol is 10 nm to 100 nm;

the film former is Acrylic Acid-2-Hydroxypropyl Acrylate Copolymer, carboxymethyl hydroxyethyl cellulose, hydroxyethyl carboxymethyl cellulose, polyethylene glycol, or water-soluble silicone oil;

the surfactant is octylphenol polyoxyethylene ether, fatty alcohol polyoxyethylene ether, allyl polyoxyethylene polyoxypropylene epoxy ether, Lauric diethanolamide, Tweens, or polyoxyethylene fatty acid;

the polishing accelerator is a sodium or potassium salt of ferrate, persulfate, permanganate, dichromate, perchlorate, hypochlorite or periodate;

the pH adjuster is ammonia water, sodium carbonate, triethanolamine, methylamine, tetramethylammonium hydroxide, or a combination of sodium carbonate and tetramethylammonium hydroxide, or a combination of methylamine and hexamethylenetetramine.

As a more preferred formulation, 100 parts by weight of the polishing liquid comprises:

15 parts of silica sol and 2 parts of ceria sol as abrasive, 0.15 parts of polyethylene glycol as film former, 0.2 parts of Lauric diethanolamide as surfactant, 2 parts of potassium hypochlorite as polishing accelerator, and 7 parts of tetramethylammonium hydroxide as pH adjuster, and deionized water in balance;

or 3 parts of silica sol as abrasive, 0.2 parts of water-soluble silicone oil as film former, 0.02 parts of Lauric diethanolamide as surfactant, 0.05 parts of potassium hypochlorite as polishing accelerator, and 0.1 parts of tetramethylammonium hydroxide as pH adjuster, and deionized water in balance;

or 15 parts of silica sol as abrasive, 0.2 parts of hydroxyethyl carboxymethyl cellulose as film former, 0.1 parts of fatty alcohol polyoxyethylene ether as surfactant, 0.1 parts of sodium persulfate as polishing accelerator, and 6 parts of sodium carbonate as pH adjuster, and deionized water in balance;

or 1 part of silica sol as abrasive, 0.02 parts of Acrylic Acid-2-Hydroxypropyl Acrylate Copolymer as film former, 0.06 parts of polyoxyethylene fatty acid as surfactant, 0.05 parts of sodium perchlorate as polishing accelerator, and 2 parts of methylamine as pH adjuster, and deionized water in balance;

or 10 parts of silica sol, and 5 parts of titania sol as abrasive, 0.15 parts of hydroxyethyl carboxymethyl cellulose as film former, 0.06 parts of allyl polyoxyethylene polyoxypropylene epoxy ether as surfactant, 0.5 parts of potassium permanganate as polishing accelerator, and 1 part of tetramethylammonium hydroxide as pH adjuster, and deionized water in balance.

Another purpose of the present invention is to provide a method for preparing the polishing liquid, and the method comprises the following steps:

1) the abrasive is mixed with water while stirring and mixed well;

2) the surfactant is added into the solution of step 1) while stirring, and stirred continuously to uniformity after the addition is completed;

3) the film former is added into the solution obtained in step 2) while stirring, and stirred continuously to uniformity after the addition is completed;

4) the pH adjuster is added into the solution obtained in step 3) while stirring, and stirred continuously to uniformity after the addition is completed;

5) the polishing accelerator is added into the solution obtained in step 4) while stirring, and stirred continuously after the addition is completed until all the components are mixed well;

6) the solution obtained in step 5) is filtered to give the polishing liquid.

According to existing methods, if the components other than the abrasive are directly mixed, interactions will occur between the components and their due roles will be affected. For example, involvement occurring between the molecular chains of the film former and the surfactant may affect the due role of the film former and the surfactant, and may be disadvantageous to the due improvement of the surface activity and dispersibility of the abrasive, and film-forming property of the polishing liquid and the like. When surface activity of the abrasive is not properly enhanced, it will not only adversely affect the cleaning of the surface of the polished wafer, such that the abrasive particles adsorbed on the surface will not be easily washed away, but also affect the dispersibility of the abrasive, and even agglomeration of the abrasive will occur. The poor film-forming property of the polishing liquid may result in that the distribution uniformity of the polishing liquid on the polishing pad and the surface of the wafer cannot achieve the desired effect, and the polishing uniformity on the surface of the wafer is difficult to reach an ideal state, which ultimately affects the performance indexes such as removal rate of the polishing liquid, surface roughness and TTV of the polished wafer, and the subsequent cleaning quality. However, adding each raw material in the above order can avoid the occurrence of the above situations to the greatest extent, and improve the final polishing performance of the polishing liquid.

Preferably, if the abrasive includes two or more components, the method further includes an operation of uniformly mixing the abrasive in advance.

Preferably, the employed surfactant, film former, pH adjuster, polishing accelerator and the like are dissolved or diluted with water before being added into the abrasive. These reagents are either solid or liquid with a certain viscosity, and the employed colloidal abrasive also has a certain viscosity, if these reagents are directly added to the abrasive, they are not easy to uniformly disperse, even if the stirring time is prolonged. During the dissolution of the solid reagents, due to the strong adsorption force of the nanometer-sized abrasives, it will lead to adsorption of the abrasives around the solid reagents and wrapping of the solid reagents, which prevents or slows down continuous dissolution thereof. These reagents that cannot be completely diluted or dissolved will be filtered out during filtration, which will seriously affect the performance of the polishing liquid.

Preferably, during the process of dissolving or diluting the surfactant, it is necessary to stir well, and within the allowable range, the more water is added, the better.

Preferably, the rotation speed of the stirrer during the mixing is the highest stirring speed that does not cause splash of the polishing liquid. The faster the speed, the easier the polishing liquid can be mixed well, and the shorter the mixing time is. If the polishing liquid splashes during stirring, the abrasive in the polishing liquid that is spattered onto the stirring rod and stirred vessel will produce dry crystals, most of the dry crystals will fall into the polishing liquid, the dry and crystallized abrasive cannot be re-dispersed, and the hardness thereof is much higher than that of colloidal abrasive. Moreover, the fine crystallized abrasive is difficult to be removed by filtration, and will cause scratch on the wafer during the polishing process.

Preferably, the water used for preparing the polishing liquid is deionized water. More preferably, the employed water is pure water. Most preferably, the employed water is ultrapure water. In ultrapure water, the inorganic ionized impurities, organic impurities (alkyl benzene sulfonic acid, oil, organic iron, organic aluminum, and other hydrocarbons, etc.), particulate impurities (dust, iron oxide, aluminum, colloidal silicon, etc.), microbial impurities (bacteria, plankton, algae, etc.) and dissolved gas impurities (N2, O2, CO2, H2S, etc.) and the like have been removed to very low levels, which decreases or reduces the influence factor on the performance of the polishing liquid.

Preferably, the duration of the continuous stirring of steps 1) to 4) is 5 to 7 min; the duration of the continuous stirring of step 5) is 10 to 15 min. The above stirring time can allow mixing the raw materials thoroughly without bringing about the waste of time induced by long mixing time.

As a preferred solution, the solution of the present application comprises the following steps:

1) the surfactant, film former, pH adjuster, and polishing accelerator are dissolved or diluted with ultrapure water separately; and a sufficient amount of ultrapure water is added and stirred well during the dissolution or dilution of the surfactant;

2) the abrasive is mixed with water while stirring, and stirred for 5 to 7 min to achieve uniformity;

3) the dissolved or diluted surfactant is added into the solution of step 2) while stirring, and after the addition is completed, continuously stirred for 5 to 7 min to achieve uniformity;

4) the dissolved or diluted film former is added into the solution obtained in step 3) while stirring, and after the addition is completed, continuously stirred for 5 to 7 min to achieve uniformity;

5) the dissolved or diluted pH adjuster is added into the solution obtained in step 4) while stirring, and after the addition is completed, continuously stirred for 5 to 7 min to achieve uniformity;

6) the dissolved or diluted polishing accelerator is added into the solution obtained in step 5) while stirring, and after the addition is completed, continuously stirred for 10 to 15 min until all the components are mixed well;

7) the solution obtained in step 6) is filtered to give the polishing liquid.

The last purpose of the present invention is to seek protection of the use of the polishing liquid described in the present application in polishing of GaAs wafer.

As a preferred use mode, the polishing liquid may be repeatedly used during the polishing process.

The polishing liquid of the present invention can be used multiple times. After polishing is completed once, the polishing liquid is filtered to be used continuously.

As a preferred mode, a filtering device is added in the input pipeline for the polishing liquid. After the polishing is completed, the polishing liquid enters the liquid storage tank through drainage, and then is pumped into the input pipeline, and recycled after being filtered through the filtering device in the input pipeline.

The polishing liquid of the present invention has the following advantageous effects:

1) When GaAs wafer is polished with the polishing liquid of the present invention, all performance indexes, such as polishing removal rate, surface roughness and TTV of the polished wafer are satisfactory, wherein the polishing effect is stable, the removal rate is higher than 1 μm/min, the roughness is less than 0.2 nm, and the TTV is less than 5 μm. In addition, the polishing liquid is easy to be washed away, does not corrode equipment, and does not introduce harmful metal ions.

2) The polishing liquid provided by the present invention can be recycled for 6 to 10 hours. During the recycle, the performance indexes, such as the polishing removal rate of the polishing liquid, the surface roughness and TTV of the polished wafer are all kept stable, which greatly saves resources and reduces production costs.

3) The method of the present invention does not need a cleaning room or a vacuum negative-pressure stirring device. It only needs an ordinary confined space and a mixing device, which saves production costs and daily maintenance costs.

### SPECIFIC MODES FOR CARRYING OUT THE EMBODIMENTS

The following embodiments further describe the present invention in details, and the examples listed below are merely for illustrating the substantial and significant progress made by the present invention, rather than limiting the scope of the present invention. Any modification and change that can be easily made by a person skilled in the art are included in the scope of the present invention and the appended claims.

Table 1 shows the composition of the polishing liquids of Examples 1 to 13 and Comparative Examples 1 to 9 as listed, and the addition amount of each component, and the removal rate, surface roughness, and TTV of the corresponding wafer measured after a polishing test. The notes under Table 1 explain the chemicals represented by the letters in the table.

TABLE 1
The proportioning of the polishing liquid of each Example or Comparative Example,
and the tested parameters of the corresponding wafer after the polishing test

| | | Film | | Polishing | pH | pH value of | Removal | Surface | |
|---|---|---|---|---|---|---|---|---|---|
| Test | Abrasive | former | Surfactant | accelerator | adjuster | the polishing | rate | roughness | |
| Examples | (wt %) | (wt %) | (wt %) | (wt %) | (wt %) | liquid | (μm/min) | (nm) | TTV(μm) |
| Example 1 | silica sol | CMHEC0.3% | OPE | sodium | ammonia | 10.6 | 1.032 | 0.176 | 4 |
| | 30% | | 0.03% | ferrate 0.5% | water 8% | | | | |
| Example 2 | silica sol | HECMC0.2% | O-10 | sodium | sodium | 10.2 | 1.052 | 0.188 | 3 |
| | 15% | | 0.1% | persulfate | carbonate | | | | |
| | | | | 0.1% | 6% | | | | |
| Example 3 | silica sol | water- | Tween | potassium | TMAH | 11.2 | 1.091 | 0.183 | 5 |
| | 35%, | soluble | 0.005% | permanganate | 6% | | | | |
| | alumina sol | silicone | | 1% | | | | | |
| | 10% | oil 0.4% | | | | | | | |
| Example 4 | silica sol | polyethylene | AEPH | potassium | triethanolamine | 10 | 1.019 | 0.192 | 4 |
| | 5% | glycol | 0.12% | dichromate | 5% | | | | |
| | | 0.1% | | 0.2% | | | | | |
| Example 5 | silica sol | AA/HPA | LAE-9 | sodium | methylamine | 12 | 1.107 | 0.172 | 5 |
| | 1% | 0.02% | 0.06% | perchlorate | 2% | | | | |
| | | | | 0.05% | | | | | |
| Example 6 | silica sol | polyethylene | LDEA | potassium | TMAH | 11.7 | 1.173 | 0.169 | 3 |
| | 15%, ceria | glycol | 0.2% | hypochlorite | 7% | | | | |
| | sol 2% | 0.15% | | 2% | | | | | |
| Example 7 | alumina sol | AA/HPA | OPE | sodium | LSA3%, | 11.5 | 1.065 | 0.183 | 4 |
| | 10% | 0.05% | 0.01% | periodate | methylamine | | | | |
| | | | | 1.2% | 2% | | | | |
| Example 8 | zirconia sol | water- | LDEA | sodium | ammonia | 10.5 | 1.053 | 0.179 | 4 |
| | 5% | soluble | 0.05% | perchlorate | water | | | | |
| | | silicone | | 0.05% | 4% | | | | |
| | | oil 0.1% | | | | | | | |
| Example 9 | titania sol | CMHEC | O-10 | sodium | sodium | 10.6 | 1.087 | 0.185 | 5 |
| | 15% | 0.1% | 0.03% | persulfate | carbonate | | | | |
| | | | | 0.3% | 2%, | | | | |
| | | | | | TMAH | | | | |
| | | | | | 1% | | | | |
| Example 10 | silica sol | HECMC | AEPH | potassium | TMAH | 10.8 | 1.116 | 0.177 | 4 |
| | 10%, titania | 0.15% | 0.06% | permanganate | 1% | | | | |
| | sol 5% | | | 0.5% | | | | | |
| Example 11 | titania sol | polyethylene | O-10 | sodium | methylamine | 10.2 | 1.095 | 0.193 | 4 |
| | 3%, | glycol | 0.02% | perchlorate | 0.2% | | | | |
| | zirconia sol | 0.08% | | 0.1% | | | | | |
| | 3% | | | | | | | | |
| Example 12 | silica sol | water- | LDEA | potassium | TMAH | 10.2 | 1.121 | 0.186 | 3 |
| | 3%, | soluble | 0.02% | hypochlorite | 0.1% | | | | |
| | | silicone | | 0.05% | | | | | |
| | | oil 0.2% | | | | | | | |
| Example 13 | silica sol | water- | AEPH | potassium | methylamine | 12.5 | 1.009 | 0.198 | 5 |
| | 25%, | soluble | 0.4% | hypochlorite | 6% | | | | |
| | | silicone | | 2% | | | | | |
| | | oil 0.6% | | | | | | | |
| Comparative | silica sol | — | LDEA | potassium | TMAH | 10.2 | 0.916 | 0.464 | 7 |
| Example 1 | 3% | | 0.02% | hypochlorite | 0.1% | | | | |
| | | | | 0.05% | | | | | |
| Comparative | silica sol | water- | — | potassium | TMAH | 10.2 | 0.833 | 0.578 | 8 |
| Example 2 | 3% | soluble | | hypochlorite | 0.1% | | | | |
| | | silicone | | 0.05% | | | | | |
| | | oil 0.2% | | | | | | | |
| Comparative | silica sol | water-soluble | LDEA | potassium | TMAH | 10.2 | 0.597 | 0.535 | 7 |
| Example 3 | 3%, | silicone | 0.02% | hypochlorite | 0.1% | | | | |
| | | oil 0.7% | | 0.05% | | | | | |
| Comparative | silica sol | water-soluble | LDEA | potassium | TMAH | 10.2 | 0.771 | 0.433 | 7 |
| Example 4 | 3%, | silicone | 0.5% | hypochlorite | 0.1% | | | | |
| | | oil 0.2% | | 0.05% | | | | | |
| Comparative | silica sol | water-soluble | LDEA | potassium | TMAH | 10.6 | 0.668 | 0.746 | 8 |
| Example 5 | 3%, | silicone | 0.02% | hypochlorite | 6% | | | | |
| | | oil 0.2% | | 2.5% | | | | | |
| Comparative | silica sol | water-soluble | LDEA | potassium | TMAH | 12.8 | 0.754 | 0.672 | 7 |
| Example 6 | 3%, | silicone | 0.02% | hypochlorite | 5% | | | | |
| | | oil 0.2% | | 0.05% | | | | | |
| Comparative | silica sol | polyacrylamide | LDEA | potassium | TMAH | 10.4 | 0.623 | 0.417 | 7 |
| Example 7 | 3%, | 0.1% | 0.02% | hypochlorite | 0.2% | | | | |
| | | | | 0.05% | | | | | |
| Comparative | silica sol | water-soluble | 1227 | potassium | TMAH | 10.4 | 0.656 | 0.459 | 7 |
| Example 8 | 3%, | silicone | 0.02% | hypochlorite | 0.2% | | | | |
| | | oil 0.2% | | 0.05% | | | | | |
| Comparative | silica sol | water-soluble | AES | potassium | TMAH | 10.4 | 0.718 | 0.389 | 7 |
| Example 9 | 3%, | silicone | 0.02% | hypochlorite | 0.2% | | | | |
| | | oil 0.2% | | 0.05% | | | | | |

NOTE: Alumina Sol—purchased from Dalian Snowchemical S&T Co., Ltd.

Titania Sol—purchased from Hefei Xiangzheng Chemical Science and Technology Co., Ltd.

Zirconia Sol—purchased from Beijing Boyu Gaoke New Material Technology Co., Ltd.

AA/HPA—Acrylic Acid-2-Hydroxypropyl Acrylate Copolymer—purchased from Shandong Taihe Water Treatment Technologies Co., Ltd.

CMHEC—carboxymethyl hydroxyethyl cellulose—purchased from Guangzhou Jinhua Chemical Technology Co., Ltd.

HECMC—hydroxyethyl carboxymethyl cellulose—purchased from Hubei Xiangtai Cellulose Co., Ltd.

OPE—octylphenol polyoxyethylene ether—purchased from Guangzhou Ruiyang Surfactant Co., Ltd.

O-10—Peregal (fatty alcohol polyoxyethylene ether)—purchased from Xingtai Xinlanxing Technology Co., Ltd.

Water-Soluble Silicone Oil—purchased from Foshan Yingzhi Organic Silicon Materials Co., Ltd.

AEPH—allyl polyoxyethylene polyoxypropylene epoxy ether—purchased from Hangzhou Devely Technology Co., Ltd.

LDEA—Lauric diethanolamide—purchased from Guangzhou Zhonghai Chemical Co., Ltd.

LAE-9— Polyoxyethylene monolaurate (polyoxyethylene fatty acid)—purchased from Shanghai Capital Corporation

TMAH—tetramethylammonium hydroxide

LSA—hexamethylenetetramine

1227—dodecyl dimethyl benzyl ammonium chloride—purchased from Jingzhou Xinjing Chemical Co., Ltd.

AES—sodium alcohol ether sulphate—purchased from Qingdao Highly Chemical New Materials Co., Ltd.

It can be seen from Examples 1 to 13 in Table 1 that, when the polishing liquid provided by the present invention was used for polishing GaAs wafer, the removal rates of the polished wafers were 1 μm/min or more, and the highest value was 1.173 μm/min; the surface roughness of the polished wafers was less than 0.2 nm, and the lowest value was 0.169 nm; and the TTV were 5 μm or less, and the minimum was 3 μm. The surface precision was very high.

Comparative Examples 1 and 2 provided the polishing liquids prepared without the addition of a film former or a surfactant. Comparative Examples 4 to 6 provided the polishing liquids prepared with the addition amounts of the film former, surfactant, polishing accelerator, or pH adjuster exceeded the desired range. Comparative Examples 7 to 9 provided the polishing liquids prepared with the film former or surfactant replaced by other types. It can be seen from the test data that, the polishing removal rates, the surface roughness and TTV of the polished wafers of Comparative Examples 1 to 9 were relatively poor, wherein the polishing removal rates were all less than 1 μm/min, and the lowest value was reduced to 0.597 μm/min; the surface roughness was all higher than 0.2 nm, and the highest value was 0.746 nm; and the TTV were greater than 5 and the maximum value is 8 μm. The surface precision was obviously decreased.

From the polishing results of Examples 1 to 13 and Comparative Examples 1 to 2 in Table 1, it can be seen that, in the case of the film former and surfactant being added, the removal rate of the polishing liquid was relatively high, and the surface roughness and TTV after polishing were relatively low. This is because that the film former used in the present invention is favorable for the polishing liquid to form a uniform film layer on the polishing pad; the surfactant is favorable for the abrasive to maintain the dispersed state and greatly reduces the surface tension of the polishing liquid, such that the polishing liquid can be easily spread on the polishing pad; and both of the film former and surfactant contribute to the uniform distribution of the polishing liquid on the polishing pad, such that the polishing effect is always uniform.

With the increase in the content of film former or surfactant, the film formed by the polishing liquid on the polishing pad or surface of the wafer becomes thicker, and the abrasive involved in mechanical grinding is greatly reduced, resulting in that some of the corrosion layers cannot be ground off in time. The adsorption of surfactant on the surface of the wafer has a concave-convex selectivity, and the surfactant preferentially adsorbs on concave. With the increase in the content of the surfactant, the surfactant adsorbed on the surface of the wafer gradually increases, the chemical corrosion on the surface of the wafer will gradually be affected, and the balance between mechanical effect and chemical effect is gradually disrupted, resulting in a gradual deterioration of the polishing effect. In Example 13, although the test results of the removal rate, roughness and TTV still met the requirements, they dropped to the critical point. In Comparative Examples 3 and 4, the contents of the film former and the surfactant were 0.7% and 0.5%, respectively, the test results being relatively poor. Therefore, the content of film former cannot exceed 0.6%, and the content of surfactant cannot exceed 0.4%.

In the case where the content of polishing accelerator exceeds 2% and the pH of the polishing liquid exceeds 12.5, the removal rate of the polishing liquid was lowered, and the surface roughness and TTV after polishing were relatively deteriorated. The reason lies in that, when the content of the polishing accelerator exceeds a certain amount or the pH value of the polishing liquid reaches a certain level, the Zeta potential of the polishing liquid will be significantly changed, and the abrasive therein will agglomerate, thereby lowering the mechanical grinding effect of the polishing liquid. It can be seen from the test results of Example 13 and Comparative Examples 5 and 6 that, the content of the polishing accelerator and the pH of the polishing liquid have reached the critical point at 2% and 12.5, respectively, and thus, when Comparative Examples 5 and 6 exceed this critical point, various performance indexes after polishing are relatively poor.

The selected film former or surfactant should be suitable for the system of the selected colloidal abrasive, otherwise, they cannot play the desired functions and adverse effect may be generated even if they are mixed by water. For example, if the charge of the surfactant is the same as the charge of the abrasive or the surface of wafer, they will repel each other, and will not improve the surface activity and dispersity of the abrasive, or it will cause mutual repulsion between the abrasive and the surface of the wafer, so that grinding effect is not achieved or is weakened, and the balance between the chemical effect and mechanical effect of the polishing liquid is disrupted. Therefore, the polishing effect of Comparative Examples 7 to 9 is relatively poor.

### Experimental Example 1

1. Detection of Polishing Effect

The polishing effects of the above Examples and Comparative Examples were tested by the following method.

The polishing object was a 6-inch GaAs wafer. The equipments and test conditions for polishing were provided as follows:

Polishing equipment: ZYP450 reciprocating straightly-pushing/rotary gravity polisher (Shenyang Maike Material Processing Equipment Co., Ltd.)

Polishing pressure: 100 g/cm2

Rotary speed of polishing pad: 80 rpm

Rotary speed of polishing head: 60 rpm

Reciprocating speed of polishing head: 15 times/min

Polishing temperature: 25° C.

Flow rate of polishing liquid: 200 ml/min

Polishing Pad: Suba 800

Polishing time: 10 min

The GaAs wafer was affixed on a ceramic holder by paraffin. After polishing, the GaAs wafer was ultrasonically cleaned with absolute ethanol, NH4OH, H2O2, and deionized water, and dried with hot N2, and then the removal rate and surface quality of the wafer were measured. The removal rate was obtained by weighing the change in weight of wafer before and after the polishing using a Sartorius (German) CPA 225D electronic balance with a precision of 0.01 mg and calculating the removal rate on the basis of the average of the three weights obtained. The surface roughness Ra was obtained according to the average of the five values measured at five points by Dimension Edge (Brooke, German) atomic force microscope with a resolution of 0.01 nm and a detection range of 20×20 μm2. The TTV was obtained according to the average of the thickness changes before and after the polishing at 9 fixed points on the wafer measured by Mitutoyo digimatic micrometer with a precision of 1 μm.

2. Relevant Performance Test for Recycling

The performance test for recycling was performed using the polishing liquids of Example 1, Example 3, and Example 6. The polishing equipment, test conditions, and test methods were the same as described above, and only the polishing time was adjusted. The test results were shown in Table 2.

TABLE 2
Corresponding test parameters of the wafer during recycle

| Polishing | | Removal | Surface | | Polishing | | Removal | Surface | | Polishing | | Removal | Surface | |
|---|---|---|---|---|---|---|---|---|---|---|---|---|---|---|
| time of | | rate | roughness | | time of | | rate | roughness | | time of | | rate | roughness | |
| Example 1 | | (μm/min) | (nm) | TTV(μm) | Example 3 | | (μm/min) | (nm) | TTV(μm) | Example 6 | | (μm/min) | (nm) | TTV(μm) |
| 10 | min | 1.052 | 0.164 | 4 | 10 | min | 1.088 | 0.159 | 4 | 10 | min | 1.125 | 0.166 | 3 |
| 30 | min | 1.059 | 0.173 | 4 | 30 | min | 1.092 | 0.165 | 3 | 30 | min | 1.132 | 0.172 | 4 |
| 1 | h | 1.070 | 0.176 | 5 | 2 | h | 1.117 | 0.190 | 4 | 2 | h | 1.161 | 0.183 | 5 |
| 2 | h | 1.087 | 0.189 | 5 | 2 | h | 1.109 | 0.184 | 5 | 2 | h | 1.170 | 0.191 | 5 |
| 1 | h | 1.065 | 0.178 | 4 | 2 | h | 1.119 | 0.186 | 5 | 2 | h | 1.167 | 0.192 | 4 |
| 1 | h | 1.069 | 0.172 | 3 | 1 | h | 1.101 | 0.168 | 4 | 1 | h | 1.143 | 0.179 | 3 |
| 30 | min | 1.055 | 0.168 | 4 | 30 | min | 1.062 | 0.179 | 4 | 1 | h | 1.145 | 0.175 | 4 |
| 30 | min | 1.032 | 0.190 | 4 | 20 | min | 1.016 | 0.198 | 5 | 30 | min | 1.133 | 0.176 | 4 |

| | | | | | | | | | | | | | |
|---|---|---|---|---|---|---|---|---|---|---|---|---|---|
| 20 | min | 1.011 | 0.196 | 5 | — | — | — | — | 30 | min | 1.097 | 0.185 | 5 |

| | | | | | | | | | | | | |
|---|---|---|---|---|---|---|---|---|---|---|---|---|
| — | — | — | — | — | — | — | — | 20 | min | 1.045 | 0.197 | 5 |

In the three sets of test data in Table 2, the polishing liquid of Example 1 was recycled for 7 hours, the polishing liquid of Example 3 was recycled for 8.5 hours, and the polishing liquid of Example 6 was recycled for 10 hours. The polishing removal rates of GaAs wafers were all 1 μm/min or more, the surface roughness of the polished wafers was all less than 0.2 nm, and the TTV were 5 μm or less. The surface precision was kept very well. Therefore, the polishing liquid provided by the present invention keep the stability of various performance indexes such as the polishing removal rate of the polishing liquid, the surface roughness and TTV of the polished wafer. Compared with the polishing liquid that can only be used once in the prior art, the polishing liquid of the present invention greatly saves resources and reduces production costs

### Example 14

The present Example relates to a method for preparing a Polishing liquid for CMP for ultrahigh-precision GaAs wafer processing, and the method specifically includes the following steps:

The raw material composition of the polishing liquid used in the present Example was as follows: by weight percentage, 3% of silica sol as abrasive, 0.02% of Lauric diethanolamide as surfactant, 0.05% of water-soluble silicone oil as film former, 0.1% of tetramethylammonium hydroxide as pH adjuster, and 0.05% of potassium hypochlorite as polishing accelerator, and ultrapure water in balance. The above raw materials were prepared into a polishing liquid according to the following method (The pH of the resulting polishing liquid was 10.2);

1) the abrasive silica sol was mixed with ultrapure water while stirring, and stirring for 5 to 7 min until they were mixed well;

2) the surfactant Lauric diethanolamide was added into the solution of step 1) while stirring, and after the addition was completed, continuously stirred for 5 to 7 min until mixed well;

3) the film former water-soluble silicone oil was added into the solution obtained in step 2) while stirring, and after the addition was completed, continuously stirred for 5 to 7 min until they were mixed well;

4) the pH adjuster tetramethylammonium hydroxide was added into the solution obtained in step 3) while stirring, and after the addition was completed, continuously stirred for 5 to 7 min until they were mixed well;

5) the polishing accelerator potassium hypochlorite was added into the solution obtained in step 4) while stirring, and after the addition was completed, continuously stirred for 10 to 15 min until all the components were mixed well;

6) the solution obtained in step 5) was filtered to give the polishing liquid.

### Example 15

The present Example relates to a method for preparing a Polishing liquid for CMP for ultrahigh-precision GaAs wafer processing, the method specifically includes the following steps:

The raw material composition of the polishing liquid used in the present Example was as follows: by weight percentage, 40% of silica sol as abrasive, 0.03% of octylphenol polyoxyethylene ether as surfactant, 0.3% of carboxymethyl hydroxyethyl cellulose as film former, 8% of ammonia water as pH adjuster, and 0.2% of sodium ferrate as polishing accelerator, and ultrapure water in balance. The polishing liquid was prepared according to the following method (The pH of the resulting polishing liquid was 10.6);

1) the abrasive silica sol was mixed with ultrapure water while stirring, and stirring for 5 to 7 min until they were mixed well;

2) the surfactant octylphenol polyoxyethylene ether was added into the solution of step 1) while stirring, and after the addition was completed, continuously stirred for 5 to 7 min until they were mixed well;

3) the film former carboxymethyl hydroxyethyl cellulose was added into the solution obtained in step 2) while stirring, and after the addition was completed, continuously stirred for 5 to 7 min until they were mixed well;

4) the pH adjuster ammonia water was added into the solution obtained in step 3) while stirring, and after the addition was completed, continuously stirred for 5 to 7 min until they were mixed well;

5) the polishing accelerator sodium ferrate was added into the solution obtained in step 4) while stirring, and after the addition was completed, continuously stirred for 10 to 15 min until all the components were mixed well;

6) the solution obtained in step 5) was filtered to give the polishing liquid.

### Example 16

The present Example relates to a method for preparing a Polishing liquid for CMP for ultrahigh-precision GaAs wafer processing, the method specifically includes the following steps:

The raw material composition of the polishing liquid used in the present Example was as follows: by weight percentage, 15% of silica sol and 5% alumina sol as abrasive, 0.02% of Tween as surfactant, 0.2% of water-soluble silicone oil as film former, 5% of tetramethylammonium hydroxide as pH adjuster, and 1% of potassium permanganate as polishing accelerator, and ultrapure water in balance. The polishing liquid was prepared according to the following method (The pH of the prepared polishing liquid was 11.4);

1) alumina sol was added into the abrasive silica sol while stirring, and stirring for 5 to 7 min until they were mixed well;

2) in the solution of step 1), the abrasive was mixed with ultrapure water while stirring, and the stirring was carried out for 5 to 7 min to mix them well;

3) the surfactant Tween was added into the solution of step 2) while stirring, and after the addition was completed, continuously stirred for 5 to 7 min until they were mixed well;

4) the film former water-soluble silicon oil was added into the solution obtained in step 3) while stirring, and after the addition was completed, continuously stirred for 5 to 7 min until they were mixed well;

5) the pH adjuster tetramethylammonium hydroxide was added into the solution obtained in step 4) while stirring, and after the addition was completed, continuously stirred for 5 to 7 min until they were mixed well;

6) the polishing accelerator potassium permanganate was added into the solution obtained in step 5) while stirring, and after the addition was completed, continuously stirred for 10 to 15 min until all the components were mixed well;

7) the solution obtained in step 6) was filtered to give the polishing liquid.

### Comparative Example 10

The polishing liquid was prepared from the same raw materials as Example 14 according to the preparation method provided by Chinese Patent No. CN101475778A, i.e. mixing the components other than the abrasive and stirring well, and then adding the filtered abrasive to the mixture, and the mixture was mixed and stirred well.

### Comparative Example 11

The same raw materials as Example 15 were used, and the order of the addition of the surfactant and the film former was adjusted, that is, the film former carboxymethyl hydroxyethyl cellulose was added first, and then the surfactant octylphenol polyoxyethylene ether was added.

### Comparative Example 12

The same raw materials as Example 16 were used, and the order of the addition of the pH adjuster and the polishing accelerator was adjusted, that is, the polishing accelerator potassium permanganate was added first, and then the pH adjuster tetramethylammonium hydroxide was added.

### Experimental Example 2

1. Relevant Experiments of Polishing Effect

Polishing liquids prepared in Examples 14 to 16 and Comparative Examples 10 to 12 were used to polish 6-inch GaAs wafers. Three polishing tests were performed for each Example, and were represented in the form of Example 14-1, Example 14-2, and Example 14-3. Two polishing tests were performed for each Comparative Example, and were represented in the form of Comparative Example 10-1 and Comparative Example 10-2. The equipment and test conditions used for polishing were the same as those of Experimental Example 1, and the results were shown in Table 3.

From the test data of the Examples and Comparative Examples in Table 3, it can be seen that, when the polishing liquid prepared by the preparation method provided by the present invention was used, the polishing removal rate was 1.11 μm/min or more, the surface roughness of the polished wafers was 0.190 nm or less, the TTV did not exceed 4 μm, the surface precision was very high, and the stability of the polishing effect was high. However, when the polishing liquid prepared by the preparation method provided by the patent CN101475778A or the polishing liquid prepared by changing the order of addition of certain components of the present invention was used, various performance indexes after polishing were relatively poor, wherein the polishing removal rate was less than 0.98 μm/min, the surface roughness of the polished wafer was greater than 0.270 nm, the TTV was not less than 6 μm, and the surface precision was significantly reduced.

In Comparative Example 11, the film former was added first, and was preferentially interacted with the abrasive and adsorbed on the surface of the abrasive, which hindered the action of the subsequently added surfactant with the abrasive to a certain extent, and affected the full exertion of the function of the surfactant, such that the surface activity, dispersity, and agglomeration phenomenon of the abrasive cannot be properly improved, and thus, the removal rate of the polishing liquid, the surface roughness and TTV of the polished wafer were relatively poor.

In Comparative Example 12, the potassium permanganate aqueous solution is slightly alkaline, and the pH value is between 7 and 8. However, the employed abrasives, such as colloidal silica sol, colloidal alumina sol, generally have a stable pH range of about 9. In this range, the Zeta potential of the abrasive was in a stable state. When the pH value is lower than this range, the stable state of the Zeta potential of the abrasive is destroyed, and agglomerates and even gels are generated. When the pH is higher than this range and is up to 12, the Zeta potential of the abrasive is relatively stable. When the pH value exceeds 12, the stable state of the Zeta potential is destroyed, the abrasive beings to dissolve, and agglomeration occurs. The higher the pH, the faster the dissolution, and the more severe the agglomeration until gel is generated. Adding the potassium permanganate aqueous solution into the abrasive prior to the pH adjuster will cause the decrease in the pH of the abrasive, and thus the stable state of the Zeta potential is destroyed, and the agglomerate of the abrasive is generated. Even if the pH adjuster is subsequently added, it is difficult to completely recover the agglomerated abrasive, and thus, the removal rate of the polishing liquid, the surface roughness and TTV of the polished wafer were significantly deteriorated.

TABLE 3
Test parameters of the corresponding wafers polished by the polishing
liquid prepared in the Examples and Comparative Examples

| Experimental | | Surface roughness | |
|---|---|---|---|
| Examples | Removal rate (μm/min) | (nm) | TTV (μm) |
| Example 14-1 | 1.121 | 0.186 | 3 |
| Example 14-2 | 1.137 | 0.173 | 3 |
| Example 14-3 | 1.143 | 0.183 | 4 |
| Example 15-1 | 1.135 | 0.171 | 3 |
| Example 15-2 | 1.120 | 0.180 | 3 |
| Example 15-3 | 1.132 | 0.165 | 3 |
| Example 16-1 | 1.113 | 0.180 | 4 |
| Example 16-2 | 1.133 | 0.167 | 3 |
| Example 16-3 | 1.118 | 0.175 | 3 |
| Comparative | 0.916 | 0.311 | 6 |
| Example 10-1 | | | |
| Comparative | 0.932 | 0.320 | 7 |
| Example 10-2 | | | |
| Comparative | 0.963 | 0.276 | 6 |
| Example 11-1 | | | |
| Comparative | 0.975 | 0.285 | 6 |
| Example 11-2 | | | |
| Comparative | 0.832 | 0.386 | 7 |
| Example 12-1 | | | |
| Comparative | 0.845 | 0.394 | 8 |
| Example 12-2 | | | |

Although the present invention has been described in detail by general descriptions, specific embodiments and tests, it is obvious to a person skilled in the art that some modifications or improvements can be made on the basis of the present invention. Therefore, these modifications or improvements made without departing from the spirit of the present invention all fall within the protection scope of the present invention.

What is claimed is:

1. A polishing liquid for CMP, characterized in that, 100 parts by weight of the polishing liquid comprises: 0.1 to 50 parts of abrasive, 0.001 to 0.4 part of surfactant, 0.001 to 0.6 part of film former, and 0.05 to 10 parts of pH regulator, and 0.01 to 4 parts of polishing accelerator, and deionized water in balance; and the pH value of the polishing liquid is 9.5 to 12.5.

2. The polishing liquid according to claim 1, characterized in that, 100 parts by weight of the polishing liquid comprises: 1 to 45 parts of abrasive, 0.005 to 0.2 part of surfactant, 0.02 to 0.4 part of film former, and 0.1 to 8 parts of pH regulator, and 0.05 to 2 parts of polishing accelerator, and deionized water in balance; and the pH value of the polishing liquid is 10 to 12.

3. The polishing liquid according to claim 1, characterized in that, the abrasive is one or more of silica sol, alumina sol, zirconia sol, ceria sol, and titania sol.

4. The polishing liquid according to claim 3, characterized in that, the abrasive materials in the sol have a particle size of 5 nm to 150 nm, and the sol has a pH of 8 to 10.

5. The polishing liquid according to claim 1, characterized in that, the surfactant is one or more of alkylphenol ethoxylates, fatty alcohol polyoxyethylene ethers, polyoxyethylene fatty acid, ethylene oxide adducts of polypropylene glycol, sorbitan esters, Tweens and alkylolamides.

6. The polishing liquid according to claim 1, characterized in that, the film former is one or more of cellulose ethers, acrylic copolymers, polyethylene-based copolymers, hydrocarbon copolymers, or organosilicon polymers, and their mutually-modified species.

7. The polishing liquid according to claim 1, characterized in that, the pH regulator is one or more of hydroxide, alkaline inorganic salt, primary amine, tertiary amine, quaternary ammonium base and imine.

8. The polishing liquid according to claim 1, characterized in that, the polishing accelerator is one or more of ferrate, persulfate, permanganate, dichromate, perchlorate, hypochlorite and periodate.

9. The polishing liquid according to claim 1, characterized in that, the surfactant is octylphenol polyoxyethylene ether, fatty alcohol polyoxyethylene ether, allyl polyoxyethylene polyoxypropylene epoxy ether, Lauric diethanolamide, Tween, or polyoxyethylene fatty acid;
and/or, the film former is acrylic acid-2-hydroxypropyl acrylate copolymer, carboxymethyl hydroxyethyl cellulose, hydroxyethyl carboxymethyl cellulose, polyethylene glycol, or water-soluble silicone oil;
and/or, the pH adjuster is ammonia water, sodium carbonate, triethanolamine, methylamine, tetramethylammonium hydroxide, or a combination of sodium carbonate and tetramethylammonium hydroxide, or a combination of methylamine and hexamethylenetetramine;
and/or, the polishing accelerator is a sodium or potassium salt of ferrate, persulfate, permanganate, dichromate, perchlorate, hypochlorite or periodate.

10. The polishing liquid according to claim 2, characterized in that, the abrasive is one or more of silica sol, alumina sol, zirconia sol, ceria sol, and titania sol; and the pH of the sol is 8 to 10, the particle size of abrasive material is 10 nm to 100 nm;
the film former is acrylic acid-2-hydroxypropyl acrylate copolymer, carboxymethyl hydroxyethyl cellulose, hydroxyethyl carboxymethyl cellulose, polyethylene glycol, or water-soluble silicone oil;
the surfactant is octylphenol polyoxyethylene ether, fatty alcohol polyoxyethylene ether, allyl polyoxyethylene polyoxypropylene epoxy ether, Lauric diethanolamide, Tween, or polyoxyethylene fatty acid;
the polishing accelerator is a sodium or potassium salt of ferrate, persulfate, permanganate, dichromate, perchlorate, hypochlorite or periodate;
the pH adjuster is ammonia water, sodium carbonate, triethanolamine, methylamine, tetramethylammonium hydroxide, or a combination of sodium carbonate and tetramethylammonium hydroxide, or a combination of methylamine and hexamethylenetetramine.

11. The method for preparing the polishing liquid according to claim 1, characterized in that, the method comprises the following steps:
1) the abrasive material is mixed well with water while stirring;
2) the surfactant is added into the solution of step 1) while stirring, and stirred continuously to uniformity after the addition is completed;
3) the film former is added into the solution obtained in step 2) while stirring, and stirred continuously to uniformity after the addition is completed;
4) the pH regulator is added into the solution obtained in step 3) while stirring, and stirred continuously to uniformity after the addition is completed;
5) the polishing accelerator is added into the solution obtained in step 4) while stirring, and stirred continuously after the addition is completed until all the components are mixed well; and
6) the solution obtained in step 5) is filtered to give the polishing liquid.

12. The method according to claim 11, characterized in that, the method comprises the following steps:
1) the surfactant, film former, pH regulator, and polishing accelerator are dissolved or diluted with ultrapure water separately; and a sufficient amount of ultrapure water is added and stirred well during the dissolution or dilution of the surfactant;
2) the abrasive material is mixed with ultrapure water while stirring, and stirred for 5 to 7 min to achieve uniformity;
3) the dissolved or diluted surfactant is added into the solution obtained in step 2) while stirring, and after the addition is completed, stirred continuously for 5 to 7 min to achieve uniformity;
4) the dissolved or diluted film former is added into the solution obtained in step 3) while stirring, and after the addition is completed, stirred continuously for 5 to 7 min to achieve uniformity;
5) the dissolved or diluted pH regulator is added into the solution obtained in step 4) while stirring, and after the addition is completed, stirred continuously for 5 to 7 min to achieve uniformity;
6) the dissolved or diluted polishing accelerator is added into the solution obtained in step 5) while stirring, and after the addition is completed, stirred continuously for 10 to 15 min until all the components are mixed well; and
7) the solution obtained in step 6) is filtered to give the polishing liquid.

13. The use of the polishing liquid according to claim 1 in the polishing of GaAs wafer.

14. The polishing liquid according to claim 2, characterized in that, the abrasive is one or more of silica sol, alumina sol, zirconia sol, ceria sol, and titania sol.

15. The polishing liquid according to claim 2, characterized in that, the surfactant is one or more of alkylphenol ethoxylates, fatty alcohol polyoxyethylene ethers, polyoxyethylene fatty acid, ethylene oxide adducts of polypropylene glycol, sorbitan esters, Tweens and alkylolamides.

16. The polishing liquid according to claim 2, characterized in that, the film former is one or more of cellulose ethers, acrylic copolymers, polyethylene-based copolymers, hydrocarbon copolymers, or organosilicon polymers, and their mutually-modified species.

17. The polishing liquid according to claim 2, characterized in that, the pH regulator is one or more of hydroxide, alkaline inorganic salt, primary amine, tertiary amine, quaternary ammonium base and imine.

18. The polishing liquid according to claim 2, characterized in that, the polishing accelerator is one or more of ferrate, persulfate, permanganate, dichromate, perchlorate, hypochlorite and periodate.

19. The polishing liquid according to claim 2, characterized in that, the surfactant is octylphenol polyoxyethylene ether, fatty alcohol polyoxyethylene ether, allyl polyoxyethylene polyoxypropylene epoxy ether, Lauric diethanolamide, Tween, or polyoxyethylene fatty acid;
and/or, the film former is acrylic acid-2-hydroxypropyl acrylate copolymer, carboxymethyl hydroxyethyl cellulose, hydroxyethyl carboxymethyl cellulose, polyethylene glycol, or water-soluble silicone oil;
and/or, the pH adjuster is ammonia water, sodium carbonate, triethanolamine, methylamine, tetramethylammonium hydroxide, or a combination of sodium carbonate and tetramethylammonium hydroxide, or a combination of methylamine and hexamethylenetetramine;
and/or, the polishing accelerator is a sodium or potassium salt of ferrate, persulfate, permanganate, dichromate, perchlorate, hypochlorite or periodate.
